(19) United States
(12) Patent Application Publication
(10) Pub. No.: US 2026/0129000 A1
(43) Pub. Date: May 7, 2026

(54) METHODS AND SYSTEMS FOR MINIMIZING PACKET RETRANSMISSION AND BANDWIDTH PRIORITY MANAGEMENT AT A USER DEVICE

(71) Applicant: SAMSUNG ELECTRONICS CO., LTD., Suwon-si (KR)

(72) Inventors: Gunjan Kumar CHOUDHARY, Bangalore (IN); Wonbo Lee, Suwon-si (KR); Mritunjay Gupta, Bangalore (IN); Ramanathan Palaniappan, Bangalore (IN); Youngki Hong, Suwon-si (KR); Aman Bilaiya, Bangalore (IN); Rachit Bansal, Bangalore (IN); Amith Shreedhara Hande, Bangalore (IN)

(73) Assignee: SAMSUNG ELECTRONICS CO., LTD., Suwon-si (KR)

(21) Appl. No.: 19/440,158

(22) Filed: Jan. 5, 2026

Related U.S. Application Data
(63) Continuation of application No. PCT/KR2024/012245, filed on Aug. 16, 2024.

(30) Foreign Application Priority Data
Aug. 23, 2023 (IN) 202341056586
Jul. 31, 2024 (IN) 202341056586

(51) Int. Cl. H04L 47/27; H04L 1/08

(52) U.S. Cl. CPC H04L 47/27; H04L 1/08

(57) ABSTRACT

A method for minimizing packet retransmission, performed by a user device, includes determining a foreground application event associated with a foreground application; determining a background bandwidth limit associated with at least one background application; determining whether the background bandwidth limit exceeds a threshold value; based on the background bandwidth limit exceeding the threshold value, identifying a transmission protocol associated with the at least one background application; and based on the identified transmission protocol, controlling packet transmission by delaying egress traffic or adjusting an advertise window size. The method applies different control mechanisms for UDP and TCP protocols, with UDP using egress traffic delay and TCP using advertise window size adjustment. The system monitors streaming parameters and performs prioritization operations based on streaming status to optimize network performance.

### CROSS-REFERENCE TO RELATED APPLICATION

This application is a by-pass continuation application of International Application No. PCT/KR2024/012245, filed on Aug. 16, 2024, which is based on and claims priority to Indian Patent Application number 202341056586, filed on Aug. 23, 2023, and Indian Patent Application number 202341056586 filed on Jul. 31, 2024 in the Indian Patent Office, the disclosures of which are incorporated by reference herein in their entireties.

### 1. FIELD

The disclosure relates to electronic communication systems, methods, and systems for minimizing packet retransmission and bandwidth priority management at a user device.

### 2. DESCRIPTION OF RELATED ART

In computer networking systems, data flow management comprises ingress and egress traffic at a user device. The ingress traffic denotes the data entering the user device from external sources, such as a node or a server, while egress traffic represents the outward-bound data leaving the user device. Moreover, an extended berkeley packet filter (eBPF) also plays an important role in managing and analyzing these data flows. The eBPF provides network security, performance optimization, and troubleshooting functions.

In a scenario where bandwidth is scarce and data usage directly impacts costs such as on a metered network, a user faces challenges on how to prioritize real-time applications over non-real-time applications. The user prioritizes real-time applications over delay-torrent traffic such as downloads corresponding to non-real-time applications that lead to dropped packets. Due to the absence of acknowledgments, a server is prompted to resend the lost packets, incurring additional charges on the metered network. The user grapples with bandwidth constraints and escalating data retransmission expenses, highlighting the struggle to manage bandwidth allocation in real-time.

In the related art, when a user is using the real-time application, the non-priority traffic (e.g., background download, application download, background synchronization by social networking sites, uploading of photos, etc.) is controlled by the user device. However, directly controlling the background incoming traffic (i.e., ingress) results in retransmission of packets. The retransmission of packets will add the data consumption to the user's data plan. Moreover, such retransmission of packets is a result of the user device dropping the packet to decrease the flow rate from the non-real time server.

FIG. 1 illustrates a graphical representation 100 of data transmission during controlled non-real time traffic, according to a conventional technique. As illustrated by the FIG. 1, the task of downloading was initially executed at a full speed of 15 Mbps over mobile data but when a video calling application was started, the download traffic was throttled by the user device. Due to throttling of the download traffic and the corresponding server being not aware of the speed limit at a client-side (i.e., the user device), the server will keep transmitting the data at the same rate resulting in the drooping of packets at the user device. Therefore, the server has to retransmit the packets and as shown by FIG. 1, a significant amount of data is consumed to complete the task of downloading, and the user may be charged accordingly.

Some of the convention systems utilize quick user datagram protocol (UDP) internet connections (QUIC) protocol for most of the services. However, the QUIC protocol uses its congestion control mechanism to control the flow between the client and the server. In particular, the QUIC protocol corresponds to an application layer protocol i.e., from application to server, the data packets are encrypted, and the QUIC protocol cannot be modified by original equipment manufacturers (OEMs). As QUIC uses the UDP as the underlying transport protocol, no public headers are available through which the flow control between the client and server can be maintained.

Further, the advent of smartphones has led to a decline in the usage of personal computers (PCs). Smartphones possess similar capabilities and device configurations to PCs, allowing for efficient multitasking. These devices may handle multiple applications simultaneously, making such devices a popular choice for internet access. Moreover, remote work and virtual education have contributed to an exponential increase in Internet data usage, with smartphones accounting for approximately 60% of Internet traffic. The network infrastructure, however, is struggling to cope with this peak data traffic demand. Despite various attempts to solve the problem, users still face poor user experiences when accessing real-time.

The above information is presented as background information only to assist with an understanding of the disclosure. No determination has been made, and no assertion is made, as to whether any of the above might be applicable as prior art with regard to the disclosure.

### SUMMARY

According to an aspect of the disclosure, a method for minimizing packet retransmission, performed by a user device, includes determining a foreground application event associated with a foreground application at the user device; determining a background bandwidth limit associated with at least one background application at the user device; determining whether the background bandwidth limit exceeds a threshold value; based on the background bandwidth limit exceeding the threshold value, identifying a transmission protocol associated with the at least one background application; and based on the identified transmission protocol, controlling packet transmission by at least one of delaying egress traffic; or adjusting an advertise window size.

The method may include wherein the background bandwidth limit is determined based on at least one of an available bandwidth limit; or a bandwidth utilization trend at the user device.

The method may include wherein the foreground application event is associated with at least one real time application that has immediate data transmission at the user device.

The method may include wherein the transmission protocol comprises one of a user datagram protocol (UDP); or a transmission control protocol (TCP).

The method may include wherein in a case that the identified transmission protocol corresponds to the UDP, delaying egress traffic, wherein the delaying egress traffic further comprises determining an egress traffic delay value based on the background bandwidth limit, and delaying the egress traffic associated with the at least one background application at the user device based on the egress traffic delay value, wherein the egress traffic corresponds to transmission of outgoing packets from the user to an external device.

The method may include wherein in a case that the identified transmission protocol corresponding to the TCP, adjusting the advertise window size, wherein adjusting the advertise window size further comprises determining an achieved background bandwidth associated with the at least one background application at the user device; determining a window scaling factor based on at least the achieved background bandwidth and the background bandwidth limit; determining a new background bandwidth limit associated with the at least one background application based on at least one of the background bandwidth limit, the achieved background bandwidth, or the window scaling factor; determining a new advertise window size associated with the at least one background application based on at least the new background bandwidth limit; and adjusting the advertise window size based on the determined new advertise window size to minimize the packet retransmission to the user device.

The method may further include monitoring at least one streaming parameter associated with the foreground application event; detecting a streaming status associated with the foreground application event based on the at least one streaming parameter, wherein the streaming status comprises at least one of a deteriorating streaming status, a stable streaming status, or an improved streaming status, and performing a streaming prioritizing operation based on detecting the deteriorating streaming status.

The method may include wherein the at least one streaming parameter comprise at least one quality of service (QoS) parameter and at least one network traffic statistics parameter, wherein the at least one QoS parameter comprise at least one of a bitrate parameter, a buffer length parameter, a size parameter, a dropped frame parameter, or a latency parameter, and wherein the at least one network traffic statistics parameter comprises at least one bandwidth consumption parameter.

The method may further include performing a streaming conservation operation associated with the foreground application event based on detecting at least one of the stable streaming status or the improved streaming status.

The method may include wherein the threshold value is determined based on a first bandwidth requirement of the foreground application, a second bandwidth requirement for the at least one background application, and at least one window size value and at least one packet delay value.

According to another aspect of the disclosure, a system for minimizing packet retransmission at a user device includes memory storing instructions; and at least one processor. The instructions, when executed by the at least one processor individually or collectively, cause the system to determine a foreground application event associated with a foreground application at the user device; determine a background bandwidth limit associated with at least one background application at the user device; determine whether the background bandwidth limit exceeds a threshold value; based on the background bandwidth limit exceeding the threshold value, identify a transmission protocol associated with the at least one background application; and based on the identified transmission protocol, control packet transmission by at least one of delaying egress traffic; or adjusting an advertise window size.

The system may include wherein the instructions, when executed by the at least one processor individually or collectively, cause the system to determine the background bandwidth limit based on at least one of an available bandwidth limit or a bandwidth utilization trend at the user device, wherein the foreground application event is associated with at least one real time application that has immediate data transmission at the user device; identify the transmission protocol as at least one of a user datagram protocol (UDP) or a transmission control protocol (TCP).

The system may include wherein in a case that the identified transmission protocol corresponds to the UDP, the instructions, when executed by the at least one processor individually or collectively, cause the system to delay the egress traffic by determine an egress traffic delay value based on the background bandwidth limit, and delay the egress traffic associated with the at least one background application at the user device based on the egress traffic delay value, wherein the egress traffic corresponds to transmission of outgoing packets from the user to an external device.

The system may include wherein in a case that the identified transmission protocol corresponds to the TCP, the instructions, when executed by the at least one processor individually or collectively, cause the system to adjust the advertise window size by determine an achieved background bandwidth associated with the at least one background application; determine a window scaling factor advertise window based on at least the achieved background bandwidth and the background bandwidth limit; determine a new background bandwidth limit associated with the at least one background application based on at least one of the background bandwidth limit, the achieved background bandwidth, or the window scaling factor, determine a new advertise window size associated with the at least one background application based on at least the new background bandwidth limit, and adjusting the advertise window size based on the determined new advertise window size to minimize the packet retransmission to the user device.

According to another aspect of the disclosure, at least one non-transitory computer readable storage media storing computer-executable instructions that, when executed by at least one processor of a user device, cause the user device to determine a foreground application event associated with a foreground application at the user device; determine a background bandwidth limit associated with at least one background application at the user device; determining whether the background bandwidth limit exceeds a threshold value; based on the background bandwidth limit exceeding the threshold value, identify a transmission protocol associated with the at least one background application; and based on the identified transmission protocol, control packet transmission by at least one of delaying egress traffic; or adjusting an advertise window size.

### BRIEF DESCRIPTION OF THE DRAWINGS

The above and other aspects, features, and advantages of certain embodiments of the disclosure will be more apparent from the following detailed description, taken in conjunction with the accompanying drawings, wherein like characters represent like parts throughout the drawings, and in which:

FIG. 1 illustrates a graphical representation of data transmission during controlled non-real time traffic, according to a conventional technique;

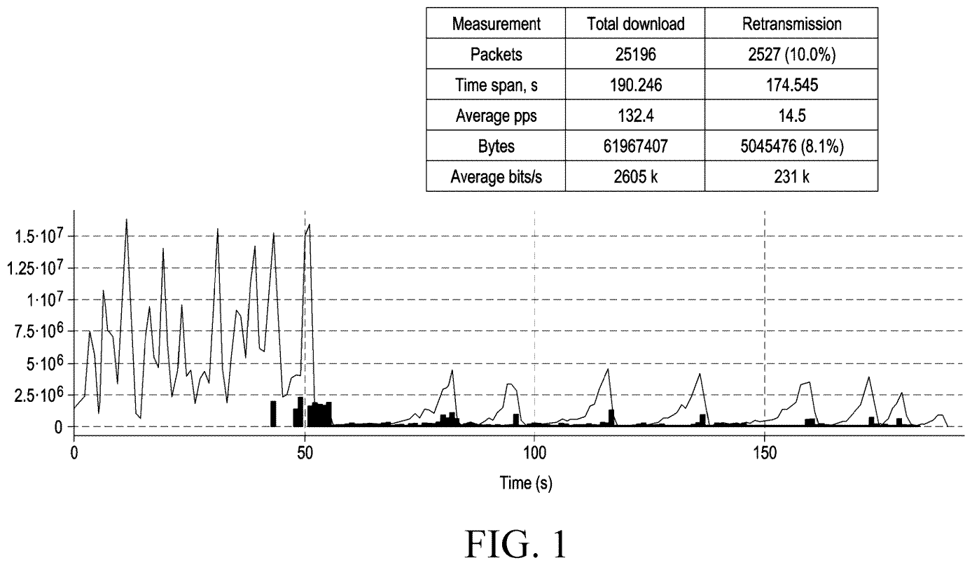

FIG. 2 illustrates an operating system (OS)-level architecture of a system, in accordance with various embodiments of the disclosure;

FIG. 3 illustrates a method of operations of the system, in accordance with various embodiments of the disclosure;

FIG. 4 illustrates a sequence of operations between a user equipment (UE) and a server, in accordance with various embodiments of the disclosure;

FIG. 5 illustrates a flow chart of a method for bandwidth priority management, according to various embodiments of the disclosure;

FIG. 6 illustrates a flow chart of a method for bandwidth priority management, according to various embodiments of the disclosure;

FIG. 7 is a schematic diagram illustrating the controlling of TCP sessions at the UE, according to various embodiments of the disclosure;

FIG. 8 is a schematic diagram illustrating a result of TCP retransmission control, according to various embodiments of the disclosure;

FIG. 9 illustrates an exemplary scenario of egress delay for QUIC protocol, according to various embodiments of the disclosure;

FIG. 10 illustrates a flow chart of a method for bandwidth priority management, according to various embodiments of the disclosure;

FIG. 11 illustrates a flow chart of a method for prioritizing streaming, according to various embodiments of the disclosure;

FIG. 12 illustrates a flow chart of a method for minimizing packet retransmission at a user device, according to various embodiments of the disclosure; and

FIG. 13 illustrates a flow chart of a method for bandwidth priority management for one or more applications in a user device, according to various embodiments of the disclosure.

Further, skilled artisans will appreciate that elements in the drawings are illustrated for simplicity and may not have necessarily been drawn to scale. For example, the flowcharts illustrate the method in terms of operations involved to help to improve understanding of aspects of the disclosure. Furthermore, in terms of the construction of the device, one or more components of the device may have been represented in the drawings by conventional symbols, and the drawings may show those specific details that are pertinent to understanding the various example embodiments of the disclosure so as not to obscure the drawings with details that may be readily apparent to those of ordinary skill in the art.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

The expressions “at least one of A, B and C” and “at least one of A, B, or C”, both indicate “A”, only “B”, only “C”, both “A and B”, both “A and C”, both “B and C”, and all of “A, B, and C”.

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of an implementation of any features and/or elements of the disclosure. Some embodiments have been described for the purpose of explaining one or more of the potential ways in which the specific features and/or elements of the proposed disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises,” “comprising,” or any other variations thereof, are intended to cover a non-exclusive inclusion, such that a process or method that comprises a list of steps/operations does not include only those steps/operations but may include other steps/operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the disclosure will be described below in detail with reference to the accompanying drawings.

The disclosure provides techniques for improving quality of service (QoS) such as, but not limited to latency, bitrate, and packet drops, for active applications in the user equipment (UE) by utilizing appropriate flow control mechanisms of transport layer protocols. Further, described is a technique for harnessing transport layer protocol flow control mechanisms to reduce retransmissions and subsequent data costs during application prioritization at the UE. Moreover, the technique described herein offers device-related solutions (i.e., at the UE) that do not require modification at the server.

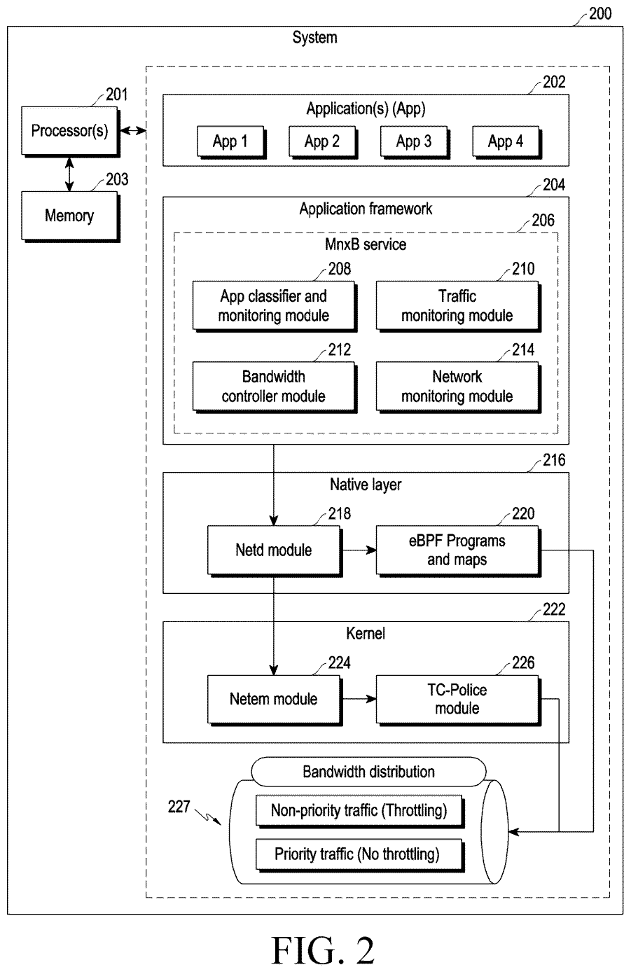

FIG. 2 illustrates an operating system (OS)-level architecture of a system 200, in accordance with an embodiment of the disclosure. In an embodiment, the system 200 may be implemented in the UE. In another embodiment, the system 200 as a whole or in part may be located remotely and communicably connected to the UE. The UE may correspond to user devices such as, but not limited to, a mobile phone, a tablet, a laptop, and so forth.

The system 200 includes one or more applications (apps) 202 configured to provide one or more services/functionalities to the user. The application 202 may correspond to a software program executed at the UE to provide one or more required services/functionalities to the user. The applications 202 may be broadly classified as, but not limited to, productivity apps (for example, note-taking apps, calendar apps, and task management apps), social networking apps, utility apps, health and fitness apps, gaming apps, and so forth. Also, the applications 202 may be classified based on a type of data transmission. For instance, the applications 202 may be classified as real-time applications that require immediate data transmission and provide instant responses to user actions. Examples of such real-time applications include, but are not limited to, video conferencing applications, messaging applications, and so forth. The applications 202 may further be classified as non-real time applications that are delay-tolerant applications where the timing of response is not critical. For non-real time applications, data processing and transmission can be delayed without affecting the user experience. Examples of such non-real time applications may include, but are not limited to, utility applications.

The system 200 further includes an application framework 204. The application framework 204 enables a user (for example, a developer) to access application programming interfaces (APIs) and manage basic functions of the system 200. Such functions may include, but are not limited to, resource allocation, switching between processes or programs, logs creating, etc. In an exemplary embodiment, the application frame 204 may execute a service program 206 (for example, MnxB service) via one or more modules, i.e., an app classifier and monitoring module 208, a traffic monitoring module 210, a bandwidth controller module 212, and a network monitoring module 214.

The app classifier and monitoring module 208 may be configured for monitoring current foreground activities and classifying the priority and non-priority traffic. In particular, the app classifier and monitoring module 208 may be configured to categorize network traffic generated by different applications 202 into priority and non-priority traffic based on one or more specified criteria, for instance, based at least on a type of application. In one embodiment, the priority traffic corresponds to the network traffic generated by the applications 202 that require immediate and uninterrupted network access for their core functionalities. Examples of priority traffic may include, but are not limited to, real-time communication apps (like voice over internet protocol (VOIP) or video conferencing) data packets, emergency services, critical system updates, or any application that the user has designated as high-priority. Whereas the non-priority traffic corresponds to the network traffic that is generated by the applications 202 that do not require immediate or uninterrupted network access, for example, social media apps, news apps, weather updates, and other non-critical services. In one embodiment, the app classifier and monitoring module 208 is configured to a bandwidth controller module 212.

The application framework 204 also includes a traffic monitoring module 210 that is configured to fetch traffic statistics of priority and non-priority applications. The traffic monitoring module 210 may be configured to compare the network traffic with a corresponding threshold value. For instance, during the priority traffic, the traffic monitoring module 210 may be configured to monitor and compare the non-priority traffic with a specified threshold. The specified threshold may be determined based on the total bandwidth of a network channel 227 between the UE and a network device (for example, a server), and the priority traffic. The traffic monitoring module 210 may be configured to share an outcome of the above-mentioned comparison to the bandwidth controller module 212 as feedback.

The application framework 204 also includes a network monitoring module 214 configured to monitor and identify an interface between the UE and the network device. In particular, the network monitoring module 214 may be configured to identify an interface corresponding to the current network traffic to determine a link/channel capacity of the network channel 227 between the UE and network device.

The bandwidth controller 212 of the application framework 204 may be configured to collect information and/or data from all the modules including the app classifier and monitoring module 208, the traffic monitoring module 210, and the network monitoring module 214. In one embodiment, the bandwidth controller 212 may be configured to analyze the received information and/or data from the various modules and determine if the non-priority traffic on the network channel 227 should be controlled. In particular, the bandwidth controller 212 may be configured to determine when to control the bandwidth of the non-priority applications (i.e., the applications generating the non-priority data). The bandwidth controller 212 may also be configured to determine bandwidth for the non-priority applications, advertise window size (i.e., the transmission of the determined bandwidth and/or window size for the non-priority applications to corresponding network servers), and a delay timer of non-priority applications data traffic. The bandwidth controller 212 may be communicably coupled with a Netd module 218 of a native layer 216 of the system 200. The bandwidth controller 212 may be configured to transmit the determined bandwidth parameters and/or characteristics of the non-priority network applications data traffic to the Netd module 218.

The system 200 may further include the native layer 216 which includes a plurality of low-level components of the OS. The native layer 216 may act as an interface between the applications 202 and/or one or more hardware components of the system 200. The native layer 216 may be configured to provide performance optimizations, direct hardware access, and system-level functionalities.

The native layer 216 includes the Netd module 218 and an extended berkeley packet filter (eBPF) program and maps 220. The Netd module 218 may be configured to interact with a kernel 222 of the system 200 and the application framework 204. The Netd module 218 may be configured to forward a request for adjusting the bandwidth for the non-priority application and unique identifiers (UID) for the priority application, and a delay or the window size in the eBPF program and maps 220.

The eBPF program and maps 220 enable an exchange of data between the eBPF programs in a kernel space and the rest of the system 200 in a user space. The eBPF maps store essential information about the UIDs for priority and non-priority applications, advertised window size, and the delay for egress (outgoing) traffic. Further, the eBPF programs may correspond to small programs executed with the kernel space without modifying the kernel 222. In particular, the eBPF programs may intercept and process the network traffic at various stages and enable advanced network analysis. The eBPF programs may enable the altering and modification of various parameters communicated by the service program 206 and stored by the eBPF maps.

The kernel 222 acts as an intermediary between the one or more hardware components and one or more software layers of the system 200. The kernel 222 may be responsible for managing system resources, providing essential services, and facilitating communication between the hardware components and the software applications (for example, the application 202). The kernel 222 may be configured to perform functions such as, but not limited to, hardware abstraction, process management, device drivers, memory management, security, and so forth.

The kernel 222 may include a Netem module 224 and a traffic control (TC)-police module 226. The Netem module 224 may be configured to manage the network traffic and implement QoS features to control the flow of the network packets and adjust the bandwidth of the non-priority traffic in the network channel 227. The Netem module 224 may be configured to direct the TC-police module 226 to control the bandwidth of the non-priority application traffic. The TC-police module 226 may be configured to adjust the traffic for the non-priority applications.

In one embodiment, the system 200 may also include one or more processors/controllers 201 (hereinafter referred to as the processor 201) and a memory 203. In one embodiment, the processor 201 may include at least one data processor for executing processes in virtual storage area network. The processor 201 may include specialized processing units, such as integrated system (bus) controllers, memory management control units, floating point units, graphics processing units, digital signal processing units, etc. In one embodiment, the processor 201 may include a central processing unit (CPU), a graphics processing unit (GPU), or both. The processor 201 may be one or more general processors, digital signal processors (DSPs), application-specific integrated circuits, field-programmable gate arrays (FPGAs), servers, networks, digital circuits, analog circuits, combinations thereof, or other now known or developed devices for analyzing and processing data. The processor 201 may execute a software program, such as code generated manually (i.e., programmed) to perform the desired operation. The processor 201 may implement various techniques such as, but not limited to, image processing, data extraction, artificial intelligence (AI), machine learning (ML), deep learning (DL) and so forth to achieve the desired objective.

In some embodiments, the memory 203 may be communicatively coupled to the processor 201. The memory 203 may be configured to store data and instructions executable by the processor 201. In one embodiment, the memory 203 may communicate via a bus within the system 200. The memory 203 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 203 may include a cache or random-access memory for the processor 201. In alternative examples, the memory 203 is separate from the processor 201, such as a cache memory of a processor, the system memory, or other memory. The memory 203 may be an external storage device or database for storing data. The memory 203 may be operable to store instructions executable by the processor 201. The functions, acts or tasks illustrated in the figures or described may be performed by the programmed processor 201 for executing the instructions stored in the memory 203. The functions, acts or tasks are independent of the particular type of instructions set, storage media, processor or processing strategy and may be performed by software, hardware, integrated circuits, firmware, micro-code, and the like, operating alone or in combination. Likewise, processing strategies may include multiprocessing, multitasking, parallel processing, and the like. The memory 203 may further include a database to store the data. Further, the memory 203 may include an operating system for performing one or more tasks of the system 200, as performed by a generic operating system in the communications domain.

In an exemplary embodiment, the processor 201 is configured to control packet transmission based on an identified transmission protocol type. When the transmission protocol type corresponds to UDP, the processor 201 delays egress traffic. When the transmission protocol type corresponds to TCP, the processor 201 adjusts an advertise window size.

In an exemplary embodiment, the processor 201 in communication with the memory 203 may be configured to perform the one or more operations/functions of the system 200, as discussed herein.

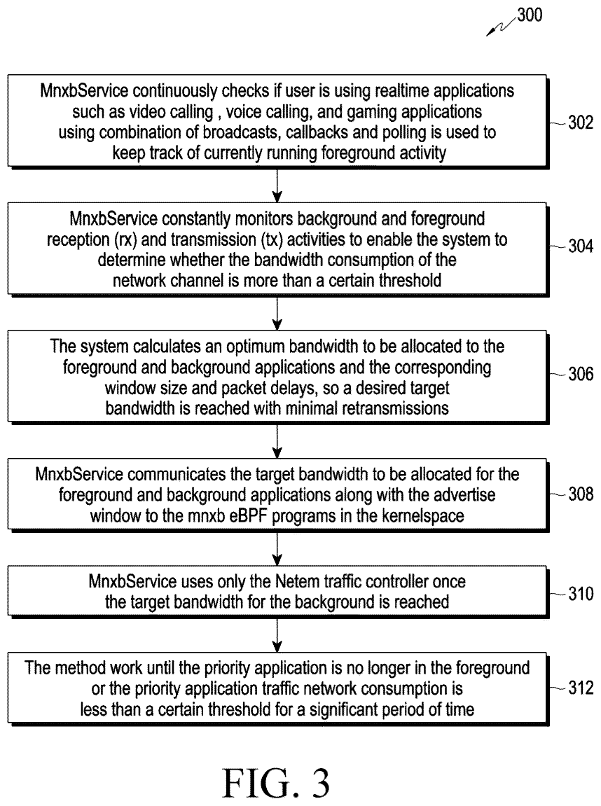

FIG. 3 illustrates a method 300 of operations of the system 200, in accordance with an embodiment of the disclosure. In one embodiment, the method 300 may be performed by one or more components of the application framework 204.

At operation 302, the Mnxb service 206 continuously checks if the user is using real-time applications such as video calling, voice calling, and gaming applications using a combination of broadcasts, callbacks, and polling features associated with currently running foreground activities. In particular, the system 200 monitors the currently running activities on the UE and determines if the user is using a real-time application/priority application or a non-real-time/non-priority application using the application framework 204.

At operation 304, the Mnxb service 206 constantly monitors background and foreground reception (rx) and transmission (tx) activities to enable the system 200 to determine whether the bandwidth consumption of the network channel 227 is more than a certain threshold. In particular, the system 200 may calculate an optimum/target bandwidth to be allocated to the foreground and background applications and the corresponding window size and packet delays, so a desired target bandwidth is reached with minimal retransmissions. The system 200 may utilize the Mnxb service 206 to calculate the optimum/target bandwidth to be allocated to different applications 202.

At operation 306, the Mnxb service 206 may employ the Netem module 224 and TC-Police module 226 of kernel 222 to control traffic at the network channel and advertise window control until the optimum/target bandwidth is reached. In one embodiment, the system 200 may utilize the advertise window size operation for transmission control protocol (TCP) header if the transport layer protocol corresponds to TCP and uses packet delays if the transport layer protocol is UDP.

At operation 308, the Mnxb service 206 communicates the optimum/target bandwidth to be allocated for the foreground and background applications along with the advertise window to the eBPF programs in the kernel space. The eBPF programs make corresponding modifications to the packets to achieve flow control to a desired level and the TC-police module 226 adjusts the priority and non-priority traffic for optimum functioning of the foreground applications and maximum utilization of available link speed at the network channel 227. In particular, the TC-police module 226 may prioritize the flow of the network traffic corresponding to the priority applications and de-prioritize the flow of the network traffic corresponding to the non-priority applications.

At operation 310, the Mnxb service 206 may utilize the Netem module 224 once the target bandwidth for the background is reached. In particular, the Mnxb service 206 may enable the system 200 to employ both Netem module 224 and advertise window size control if TC-police module 226 is unable to limit the background applications to required values or if there is a significant change in the network condition which might increase the number of packet drops and subsequent retransmissions. If there is a change in the network bandwidth, the bandwidth needs to be controlled, particularly in case a decrease of the bandwidth is needed, the method 300 may include performing advertise window control. For example, if the Netem module 224 is used to control the bandwidth, the Netem module 224 will direct to the TC-police to control bandwidth leading to dropping of incoming packets and/or retransmission of packets. Therefore, to avoid such conditions, the method 300 includes controlling the bandwidth using the advertise window control and application of the TC-police rule via the Netem module 224. Furthermore, once the bandwidth is controlled, the TC-police may be used to control the bandwidth.

At operation 312, the method 300 continues to work until the priority application is no longer in the foreground or the priority application traffic network consumption is less than a certain threshold for a significant period of time.

In particular, to avoid retransmission of packets when the non-priority application traffic is downloading at a higher rate and the priority application data rate is not able to achieve an optimal level where the user quality of service (QoS) and experience can be maintained. The disclosure proposes two following two approaches based on a type of protocol:

For TCP—the method 300 may use TCP advertise window control through TCP acknowledgement (ACK) to control the sending rate from server.

For TCP and UDP protocol—The method 300 may include delaying the outgoing i.e., egress packets from the UE, so that the server will delay in sending the packets to the client (UE). In the case of TCP, the ACK may be delayed which will slow down the sending rates from the server. Whereas in the UDP the request to server may be delayed, and if it is QUIC traffic, which also ACK mechanism, the delayed packets from the UE may also slow the sending rate from the server.

Embodiments illustrated in reference to FIG. 3 are exemplary, and the method 300 may be performed in any suitable manner in view of the number and sequence of the operations as shown in FIG. 3.

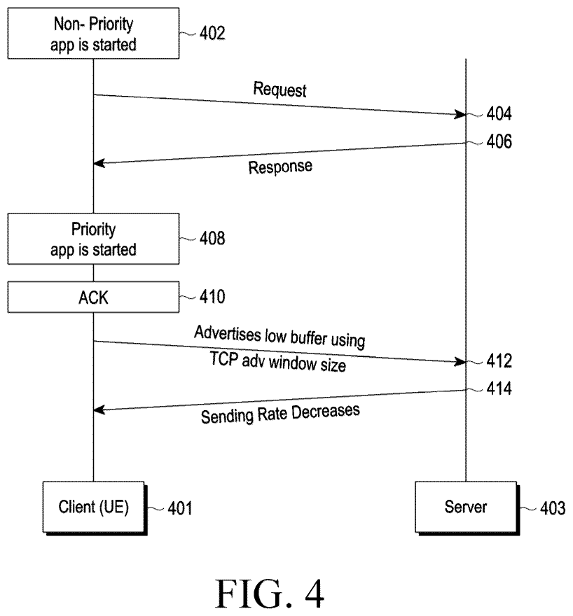

FIG. 4 illustrates a sequence of operations between a UE 401 and a server 403, in accordance with an embodiment of the disclosure. The UE 401 may correspond to the user device and/or the UE as referred to throughout the description. The server may correspond to an application server, or a network server that is configured to support one or more functionalities of applications installed within the UE 401. In one embodiment, the system 200 may be implemented at the UE 401.

At operation 402, a non-priority application is started at the UE 401. For instance, the user of the UE 401 initiates a social networking application. Therefore, at operation 404, the non-priority application transmits a request to the server 403 for required information and/or data. At operation 406, the server 403 transmits a response message to the UE 401. The response message may include the required information and/or data as requested by the non-priority application. At operations 404 and 406, the data being transmitted and received from and at the UE 401 may be referred to as non-priority network traffic.

At operation 408, a priority application is started at the UE 401. For instance, the user of the UE 101 initiates a real-time video conferencing calling application. In response to the initialization of the priority application, the native layer 216 and/or eBPF programs and maps 220 may modify the advertise window size for non-priority network traffic and generate an ACK 410.

At operation 412, the UE 401 may advertise a low buffer for the non-priority applications to the server 403 using TCP advertise window size.

In response to the advertised low buffer, at operation 414, the server 401 transmits the non-priority traffic with a reduced sending rate. Thus, the disclosure informs the server 403 about the buffer remaining with the client (the UE 401) to enable the server 403 to select the appropriate transmission rate and reduce packet retransmission. In particular, with a reduced sending rate from the server 403, there will be less packet drops when the overall bandwidth of the network channel 227 is controlled to accommodate the priority/real-time applications. Moreover, due to the reduction in packet drops, there will be less data consumption at the UE 401 and/or the server 403.

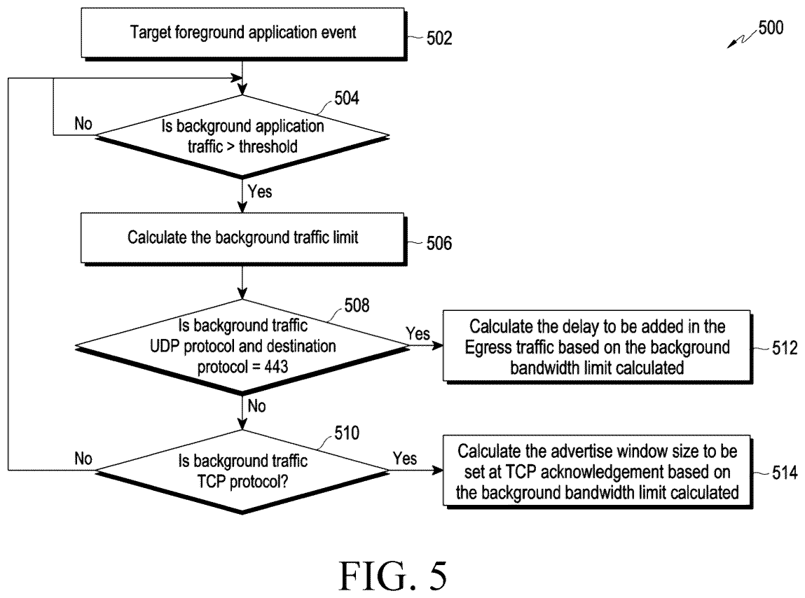

FIG. 5 illustrates a flow chart of a method 500 for bandwidth priority management, according to an embodiment of the disclosure. The method 500 may be performed by the system 200.

At operation 502, the method 500 may include detecting a target foreground application event. The target foreground application event may be triggered when a real-time application like a multi-player online game or video calling application is launched and/or initiated by the user.

At operation 504, the method 500 may include determining if background application traffic is within the specified threshold. The background application traffic may correspond to the network traffic that is a result of non-real time application and/or background running applications. The method 500 may include performing a periodic check to determine if the background application traffic and/or upload data traffic is using more than a specified bandwidth threshold of the network channel 227. Upon determining that the background application traffic and/or upload data traffic is using more than the specified bandwidth threshold of the network channel 227, the method 500 may move to operation 506.

At operation 506, the method 500 may include calculating a background traffic limit. In one embodiment, the background traffic limit may be determined based on the available bandwidth of the network channel 227 and/or the increasing/decreasing trend (simple moving average (SMA)—exponential moving average (EMA) comparison) of usage in priority/real-time applications. The increasing/decreasing trend may be explained as below:

Increasing trend: When the priority application traffic pattern is a SMA < or very near to an EMA, the scenario may be considered as increasing or stable state of the priority application traffic pattern. Therefore, a larger amount of overall bandwidth may be allocated as controlled background bandwidth, i.e., the background traffic will be allocated more bandwidth.

Decreasing Trend: When SMA is greater than the EMA the priority application traffic is considered to be decreasing, and this may be because the background application traffic is exhausting the overall available bandwidth to the UE.

At operation 508, the method 500 may include determining if the background traffic corresponds to the UDP protocol and has a destination port of 443.

Upon determining that the background traffic corresponds to the UDP protocol and has a destination port of 443, the method 500 at operation 512 may include calculating a delay to be added to egress traffic based on the background traffic limit, as determined at operation 506. This may enable the server 403 to transmit the packets at a slower rate resulting in low packet drop and retransmission.

However, in case the background traffic does not correspond to the UDP protocol, the method 500 at operation 510 may determine if the background traffic corresponds to the TCP protocol. Upon determining that the background traffic corresponds to the TCP protocol, at operation 514, the method 500 may include calculating advertise window size to be adjusted at TCP acknowledgment based on the background bandwidth limit, as determined at operation 506. In one embodiment, the advertise window size is determined based on the determined background bandwidth limit, previous advertise window, previous background bandwidth limit and an actual speed. Alternatively, the method 500 may proceed back to operation 504.

Thus, the disclosure effectively adds delay and/or advertise window size to reduce loss of data packets and as a result reduced packet retransmission.

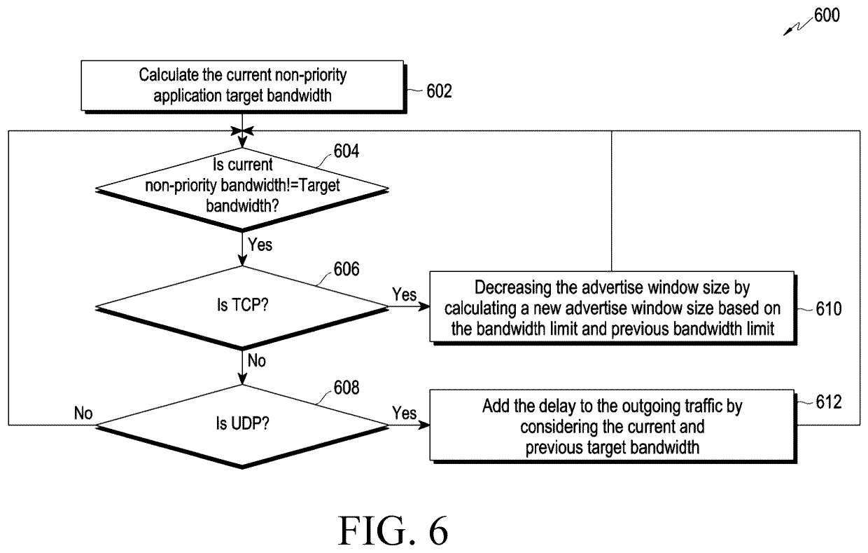

FIG. 6 illustrates a flow chart of a method 600 for bandwidth priority management, according to another embodiment of the disclosure. The method 600 may be performed subsequent to the method 500. In another embodiment, the method 600 and the method 500 may be performed simultaneously. Alternatively, the method 600 may be performed independently without any consideration for the method 500. Moreover, the method 600 may also be performed by the system 200.

At operation 602, the method 600 includes calculating the current non-priority application target bandwidth. In an embodiment, the total bandwidth of the non-priority applications traffic is summed up after every specified time interval. The non-priority application target bandwidth is calculated based on the priority application traffic pattern and overall bandwidth available after each specified time interval.

At operation 604, the method 600 may include determining if the current non-priority bandwidth is the same as the target bandwidth. In particular, the non-priority application target bandwidth is compared with the sum of non-priority application traffic. If the current non-priority bandwidth is different from the target bandwidth than an underlying transport protocol is checked.

For instance, at operation 606, the method 600 may include determining if the underlying transport protocol is TCP or not. Upon determining that the underlying transport protocol is TCP, the method 600 at operation 610 may include adjusting the advertise window size by calculating a new advertise window size based on the bandwidth limit and previous bandwidth limit. In particular, if the new target non-priority bandwidth is less than the previous target non-priority bandwidth than the new advertise window size will be less than the previous advertise window size.

However, in case the underlying transport protocol does not correspond to TCP, at operation 608, the method 600 may include determining if the underlying transport protocol corresponds to UDP.

Therefore, in response to determining that the underlying transport protocol corresponds to the UDP, the method 600 may include adding a delay to the outgoing traffic by considering the current and previous target bandwidth, as indicated by operation 612. The method 600 may be performed continuously after every specified interval till the priority application stops or no non-priority application traffic exits.

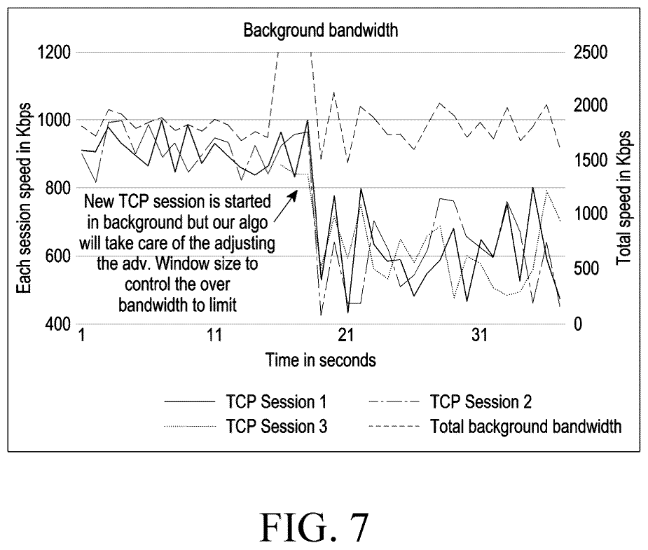

FIG. 7 is a schematic diagram illustrating the controlling of TCP sessions at the UE, according to an embodiment of the disclosure. In an embodiment, the system 200 may dynamically determine the advertise window size to control the TCP session, as also discussed in reference to FIGS. 5 and 6 corresponding to the methods 500 and 600, respectively. Since the advertise window size is used to control the TCP session's background data traffic, when a new session is added the system 200 automatically adjusts the advertise window size based on one or more previous operations. The depicted graph of FIG. 7 shows how the advertise window size is dynamically adjusted to control the overall bandwidth to 2000 Kbps. Initially, there are 2 TCP sessions concurrently going in the background and when a new TCP session is started in the background, the overall bandwidth utilization crosses the set limit of 2000 Kbps. In the next time period, the advertise window may be calculated as below:

Let the previous background bandwidth limitation be PᵣₑᵥBWₗᵢₘᵢₜ.

Let an achieved background bandwidth of all sessions be AchBW_{curr}.

Let a new limit of the background bandwidth be NewBWₗᵢₘᵢₜ.

Let the Windows scaling factor be SF.

$${AchBw}_{curr} = \sum non - priority TCP sessions speed$$

$$NewAdvWin = ( {PrevBw}_{limit} / {AchBw}_{curr} ) * ( {NewBw}_{limit} / SF )$$

With the above, the target set bandwidth is achieved. Similarly, delay is added in QUIC protocol or TCP outgoing traffic to control the background traffic.

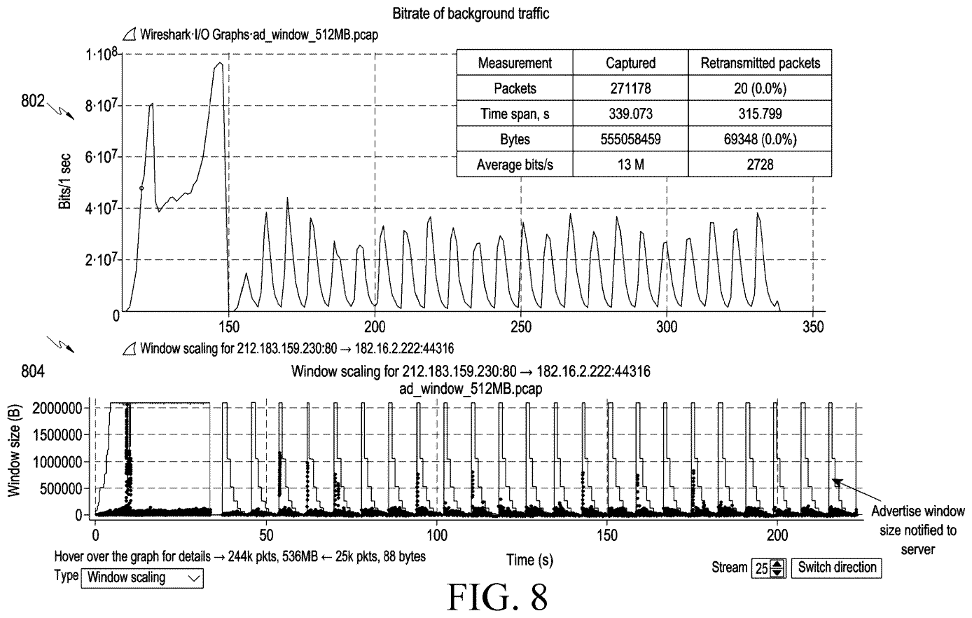

FIG. 8 is a schematic diagram illustrating a result of TCP retransmission control, according to an embodiment of the disclosure. In particular, a graph 802 indicates that when incoming bandwidth is controlled by notifying advertise window size to the server, the packet loss is decreased due to fewer retransmissions of packets. Further, a graph 804 indicates the controlled advertise window size and corresponding time interval for background applications/traffic.

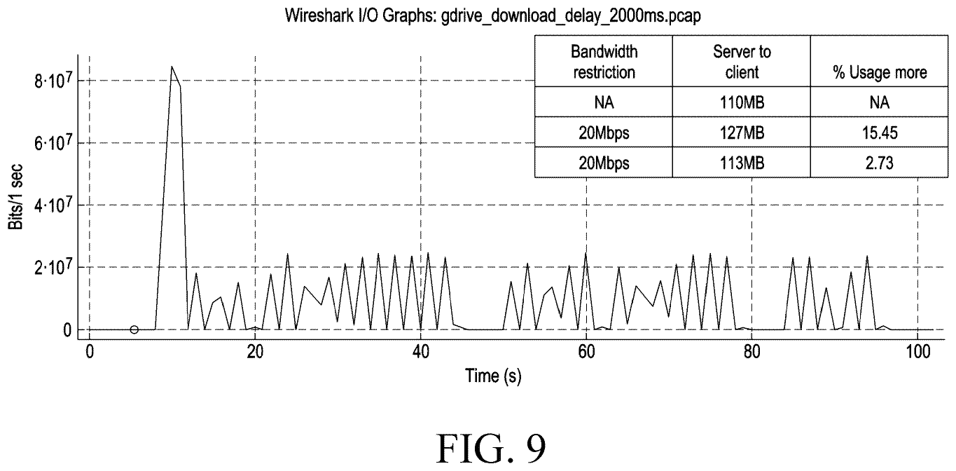

FIG. 9 illustrates an exemplary scenario of egress delay for QUIC protocol, according to an embodiment of the disclosure. In an exemplary embodiment, the background bandwidth may be controlled by adding a delay in the egress (outgoing) traffic. In particular, the TCP is dependent on ACK's to scale the traffic and/or send the next packet. If delayed ACKs are sent to a server (for example, the server 403), the server will slow down the sending rate of packets from the server to the client (for example, the UE 401). In particular, for TCP protocol-based traffic, the server has to wait for an ACK for a previous packet to transmit the next packet, therefore, if the ACK for the previous packet is delayed by the client, the traffic from the server may be delayed automatically. However, a delay to such an ACK may be determined in such a way that there should be no retransmission timer expiry. For instance, if the retransmission timer expires prior to reception of the delayed ACK from the client, the server may retransmit the initial packet. Therefore, the system 200 may determine the delay to acknowledgments such that a target bandwidth for non-priority applications is reached and retransmission timer expiry is not breached.

Further, in case of the QUIC protocol that utilizes UDP as the transport layer protocol, the data is encrypted between the application and the server. Moreover, in QUIC protocol, there is no public header that may be utilized to inform the server to decrease the sending rate of data from the server. Also, as the QUIC protocol is an encryption-based protocol, it is difficult to decipher only the ACK packets. Therefore, all the egress (outgoing) traffic from the client to the server is delayed to control the bandwidth. The system 200 may regulate the delay in such a manner that there is very less retransmission of packets. For instance, in the graph illustrated in FIG. 9, the bandwidth is regulated/controlled by adding delay to egress traffic/packets. In particular, the illustrated embodiment corresponds to a downloading scenario, where initially when a file is downloaded without any restriction, 110 MB of data is consumed as incoming packets from the server, but when the 20 Mpbs restriction is imposed on ingress (incoming) packets without any delay addition 127 MB of data is received. Therefore, there is an additional cost of 17 MB which may be incurred to the user. However, when the delay to egress traffic is applied, as discussed in the disclosure, the data received from the server is just 113 MB. Thus, 3 MB of the data is additionally received at the UE. This saves both UE and network resources and also provides a cost-effective solution to the user.

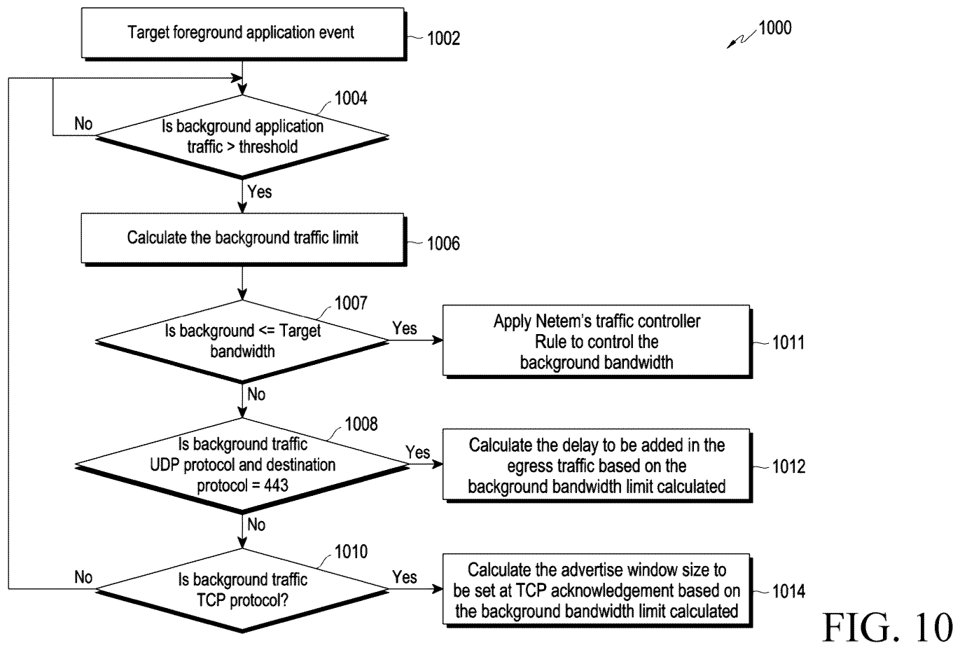

FIG. 10 illustrates a flow chart of a method 1000 for bandwidth priority management, according to yet another embodiment of the disclosure. The operations 1002, 1004, 1006, 1008, 1010, 1012, and 1014 are similar to operations 502, 504, 506, 508, 510, 512, and 514, as explained in reference to FIG. 5, therefore a description of these operations has been omitted for the sake of brevity. The method 1000 may also be performed by the system 200.

In particular, according to the method 1000, initially, the background or non-priority traffic sessions are controlled by using advertise window control for TCP or delaying the outgoing traffic for the QUIC protocol.

However, at operation 1007, the method 1000 may include determining if the background bandwidth limit is less than the target bandwidth. Upon determining that the background bandwidth limit is less than the target bandwidth, at operation 1011, the method 100 may include applying Netem's traffic controller rule to control the background bandwidth.

In particular, the method 1000 may prevent an overshooting of the target background bandwidth and also reduce the retransmission of the packets.

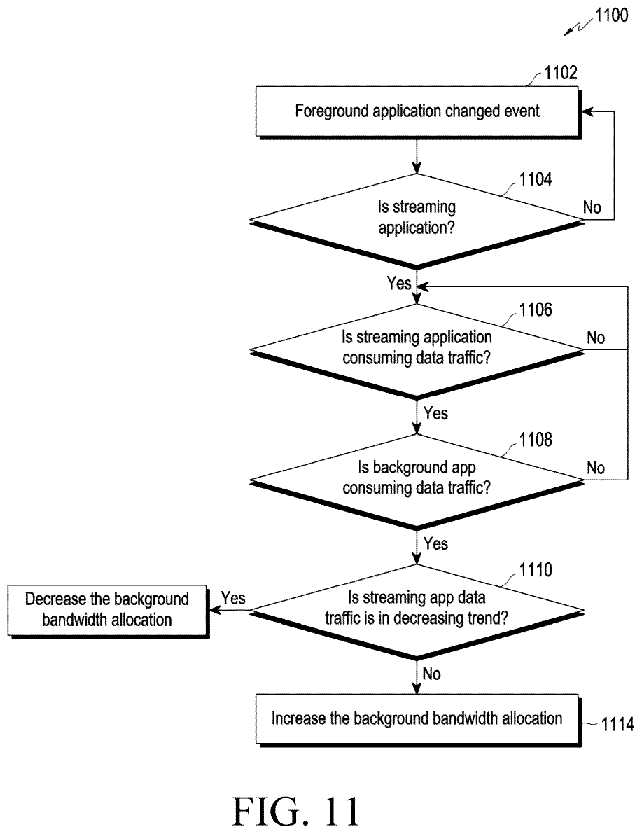

FIG. 11 illustrates a flow chart of a method 1100 for prioritizing streaming, according to yet another embodiment of the disclosure. The method 1100 may also be performed by the system 200.

At operation 1102, the method 1100 may include detecting an event corresponding to a change in foreground application.

At operation 1104, the method 1100 may include determining whether the foreground application is a streaming application. Upon determining that the foreground application does not correspond to the streaming application, the method 1100 may continue to perform operation 1102, i.e., to detect any other foreground application change event.

However, upon determining that the foreground application corresponds to the streaming application, the method 1100 may perform operation 1106. Specifically, at operation 1106, the method 1100 may include checking the streaming application traffic pattern to determine if there is any data traffic consumption or not. In case, there is no data traffic consumption by the streaming application, the method 1100 may keep on checking the data consumption by the streaming application after every specified time interval.

However, upon determining that the streaming application is consuming data traffic, the method 1100, at operation 1108, may include determining whether background application(s) is also consuming data traffic at the same time. In case, the data traffic consumption by the background application(s) is not consuming the data traffic, the method 1100 may keep on performing operation 1103, to monitor data traffic consumption by the foreground application and the background application(s). The method 1100 may also include determining if the data traffic consumption by the background application(s) is above a specified threshold or not. In case, the data traffic consumption is above the specified threshold, the method 1100 may include controlling the data traffic consumption associated with the background application(s), otherwise the method 1100 may keep on monitoring the data traffic consumption by the background application(s). Once the data traffic consumption by the background application(s) is controlled, the method 1100 may include checking the foreground application traffic pattern.

For instance, at operation 1110, the method 1100 may include determining if the streaming application data traffic is in decreasing trend or not. In particular, the method 1100 may include determining bitrate trend by comparing the SMA and EMA, as discussed above. For example, if the SMA>EMA, the trend may be determined as the decreasing trend, otherwise the trend may be considered as the increasing trend. In case of decreasing trend, i.e., data buffered by the streaming application is less than a corresponding threshold value, the background bandwidth may be controlled. For example, at operation 1112, the method 1100 may include decreasing the background bandwidth allocation. Some additional factors to determine the decreasing trend may include, but not limited to, lower video resolution of the streaming application, higher latency in network statistics, higher data packet loss, etc.

Alternatively, at operation 114, the method 1100 may include increasing the background bandwidth allocation.

Embodiments are exemplary in nature and the operations of method 1100 may be performed in any suitable variation including addition/omission of the operations.

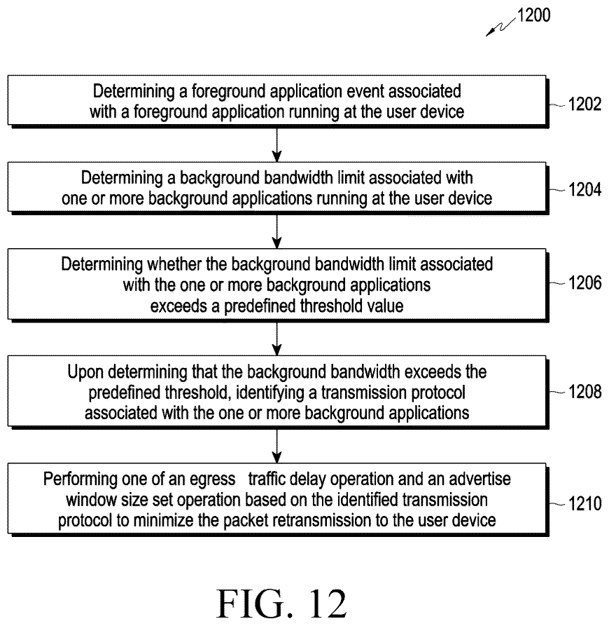

FIG. 12 illustrates a flow chart of a method 1200 for minimizing packet retransmission at a user device, according to an embodiment of the disclosure. The method 1200 may be performed by the system 200.

At operation 1202, the method 1200 includes determining a foreground application event associated with a foreground application at the user device. In one embodiment, the foreground application event is associated with one or more real-time (RT) applications at the user device.

At operation 1204, the method 1200 includes determining a background bandwidth limit associated with one or more background applications at the user device. In one embodiment, the background bandwidth limit associated with the one or more background applications at the user device is determined based on at least one of the available bandwidth limit and a bandwidth utilization trend at the user device.

At operation 1206, the method 1200 includes determining whether the background bandwidth limit associated with the one or more background applications exceeds a threshold value. In an embodiment, the threshold value is determined based on a minimum bandwidth requirement of the foreground application, a minimum bandwidth requirement for the one or more background applications, and associated window sizes and packet delays.

Moreover, at operation 1208, upon determining that the background bandwidth limit exceeds the threshold value, the method 1200 includes identifying a transmission protocol associated with the one or more background applications. In one embodiment, the transmission protocol associated with the one or more background applications is one of a UDP and a TCP.

At operation 1210, the method 1200 includes performing one of an egress traffic delay operation and an advertise window size set operation based on the identified transmission protocol to minimize the packet retransmission to the user device. In one embodiment, the egress traffic delay operation is performed when the identified transmission protocol corresponds to the UDP protocol. Moreover, the egress traffic delay operation to minimize the packet retransmission to the user device may include determining an egress traffic delay value based on the background bandwidth limit. The egress traffic delay operation further includes delaying an egress traffic associated with the one or more background applications at the user device based on the egress traffic delay value. The egress traffic corresponds to transmission of outgoing packets from the user to an external device. In an embodiment, the advertise window size set operation is performed when the identified transmission protocol corresponds to the TCP protocol. The advertise window size set operation may include determining an achieved background bandwidth associated with the one or more background applications at the user device. The advertise window size set operation may also include determining a window scaling factor based on at least the achieved background bandwidth and the background bandwidth limit. The advertise window size set operation may further includes determining a new background bandwidth limit associated with the one or more background applications at the user device based on at least the background bandwidth limit, the achieved background bandwidth, and the scaling factor. Also, the advertise window size set operation may include determining a new advertise window size associated with the one or more background applications at the user device based on at least the new background bandwidth limit. Furthermore, the method 1200 may include performing the advertise window size set operation based on the determined new advertise window size to minimize the packet retransmission to the user device.

In one embodiment, to minimize the packet retransmission to the user device associated with the one or more background applications, the method 1200 further comprises performing, a streaming prioritizing operation associated with the foreground application event. The streaming prioritizing operation may include monitoring, one or more streaming parameters associated with associated with the foreground application event. The streaming prioritizing operation may further include detecting a streaming status associated with the foreground application event based on the one or more streaming parameters. The streaming status is at least one of a deteriorating streaming status, a stable streaming status and an improved streaming status. The method 1200 may include performing the streaming prioritizing operation foreground application event based on detecting the deteriorating streaming status. In an embodiment, the one or more streaming parameters may include, but not limited to, QoS parameters and network traffic statistics. The one or more QoS parameters may include, but are not limited to, a bitrate parameter, a buffer length parameter, a size parameter, a dropped frame parameter, and a latency parameter. The Network traffic statistics parameter comprises one or more bandwidth consumption parameters. The method 1200 may further include performing a streaming conservation operation associated with the foreground application event based on detecting at least one of the stable streaming status and the improved streaming status associated with the foreground application event.

The disclosure improves QoS such as, latency, bitrate, packet drops, etc. for active/foreground applications in the UE by utilizing appropriate flow control mechanisms of transport layer protocols. The disclosure harnesses transport layer protocol flow control mechanisms to reduce retransmissions and subsequent data costs during application prioritization at the UE. Moreover, the disclosure provides a solution from a client/user device side without requiring any modification at the server.

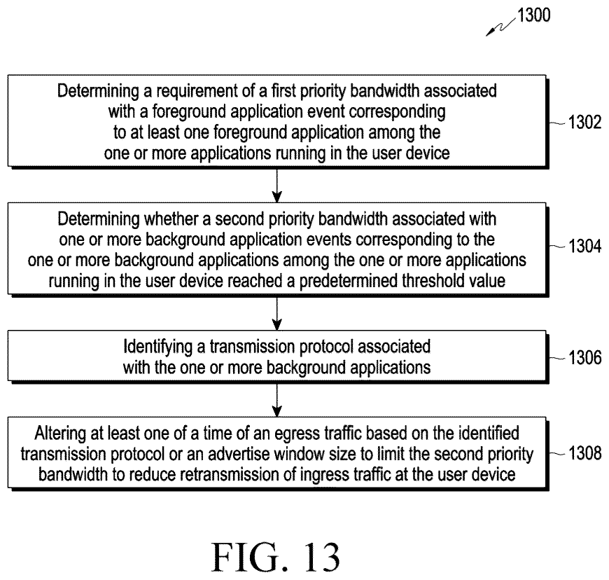

FIG. 13 illustrates a flow chart of a method 1300 for bandwidth priority management for one or more applications in a user device, according to an embodiment of the disclosure. The method 1300 may be performed by the system 200.

At operation 1302, the method 1300 may include determining a requirement of a first priority bandwidth associated with a foreground application event corresponding to at least one foreground application among the one or more applications in the user device.

At operation 1304, the method 1300 may include determining whether a second priority bandwidth associated with one or more background application events corresponding to the one or more background applications among the one or more applications in the user device reached a predetermined threshold value.

At operation 1306, the method 1300 may include determining whether a second priority bandwidth associated with one or more background application events corresponding to the one or more background applications among the one or more applications in the user device reached a predetermined threshold value.

At operation 1308, the method 1300 may include altering at least one of a time of an egress traffic based on the identified transmission protocol or an advertise window size to limit the second priority bandwidth to reduce retransmission of ingress traffic at the user device. In one embodiment, the egress traffic corresponds to transmission of outgoing packets from the user device to an external device, and the ingress traffic corresponds to transmission of the incoming packets to the user device from the external device.

The above flowcharts illustrate example methods that may be implemented in accordance with the principles of the disclosure and various changes could be made to the methods illustrated in the flowcharts herein. For example, while shown as a series of steps/operations, various steps/operations in each figure could overlap, occur in parallel, occur in a different order, or occur multiple times. In another example, steps/operations may be omitted or replaced by other steps/operations.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for minimizing packet retransmission, performed by a user device, the method comprising:
determining a foreground application event associated with a foreground application at the user device;
determining a background bandwidth limit associated with at least one background application at the user device;
determining whether the background bandwidth limit exceeds a threshold value;
based on the background bandwidth limit exceeding the threshold value, identifying a transmission protocol associated with the at least one background application; and
based on the identified transmission protocol, controlling packet transmission by at least one of:
delaying egress traffic; or
adjusting an advertise window size.

2. The method of claim 1, wherein the background bandwidth limit is determined based on at least one of:
an available bandwidth limit; or
a bandwidth utilization trend at the user device.

3. The method of claim 1, wherein the foreground application event is associated with at least one real time application that has immediate data transmission at the user device.

4. The method of claim 1, wherein the transmission protocol comprises one of:
a user datagram protocol (UDP); or
a transmission control protocol (TCP).

5. The method of claim 4, wherein in a case that the identified transmission protocol corresponds to the UDP, delaying egress traffic,
wherein the delaying egress traffic further comprises:
determining an egress traffic delay value based on the background bandwidth limit, and
delaying the egress traffic associated with the at least one background application at the user device based on the egress traffic delay value,
wherein the egress traffic corresponds to transmission of outgoing packets from the user to an external device.

6. The method of claim 4, wherein in a case that the identified transmission protocol corresponding to the TCP, adjusting the advertise window size,
wherein adjusting the advertise window size further comprises:
determining an achieved background bandwidth associated with the at least one background application at the user device;
determining a window scaling factor based on at least the achieved background bandwidth and the background bandwidth limit;
determining a new background bandwidth limit associated with the at least one background application based on at least one of the background bandwidth limit, the achieved background bandwidth, or the window scaling factor;
determining a new advertise window size associated with the at least one background application based on at least the new background bandwidth limit; and
adjusting the advertise window size based on the determined new advertise window size to minimize the packet retransmission to the user device.

7. The method of claim 1, further comprising:
monitoring at least one streaming parameter associated with the foreground application event;
detecting a streaming status associated with the foreground application event based on the at least one streaming parameter,
wherein the streaming status comprises at least one of a deteriorating streaming status, a stable streaming status, or an improved streaming status, and
performing a streaming prioritizing operation based on detecting the deteriorating streaming status.

8. The method of claim 7, wherein the at least one streaming parameter comprise at least one quality of service (QoS) parameter and at least one network traffic statistics parameter,
wherein the at least one QoS parameter comprise at least one of a bitrate parameter, a buffer length parameter, a size parameter, a dropped frame parameter, or a latency parameter, and
wherein the at least one network traffic statistics parameter comprises at least one bandwidth consumption parameter.

9. The method of claim 7, further comprising:
performing a streaming conservation operation associated with the foreground application event based on detecting at least one of: the stable streaming status or the improved streaming status.

10. The method of claim 1, wherein the threshold value is determined based on a first bandwidth requirement of the foreground application, a second bandwidth requirement for the at least one background application, and at least one window size value and at least one packet delay value.

11. A system for minimizing packet retransmission at a user device, the system comprising:
memory storing instructions; and
at least one processor,
wherein the instructions, when executed by the at least one processor individually or collectively, cause the system to:
determine a foreground application event associated with a foreground application at the user device;
determine a background bandwidth limit associated with at least one background application at the user device;
determine whether the background bandwidth limit exceeds a threshold value;
based on the background bandwidth limit exceeding the threshold value, identify a transmission protocol associated with the at least one background application; and
based on the identified transmission protocol, control packet transmission by at least one of:
delaying egress traffic; or
adjusting an advertise window size.

12. The system of claim 11, wherein the instructions, when executed by the at least one processor individually or collectively, cause the system to:
determine the background bandwidth limit based on at least one of an available bandwidth limit or a bandwidth utilization trend at the user device,
wherein the foreground application event is associated with at least one real time application that has immediate data transmission at the user device;
identify the transmission protocol as at least one of a user datagram protocol (UDP) or a transmission control protocol (TCP).

13. The system of claim 12, wherein in a case that the identified transmission protocol corresponds to the UDP, the instructions, when executed by the at least one processor individually or collectively, cause the system to delay the egress traffic by:
determine an egress traffic delay value based on the background bandwidth limit, and
delay the egress traffic associated with the at least one background application at the user device based on the egress traffic delay value,
wherein the egress traffic corresponds to transmission of outgoing packets from the user to an external device.

14. The system of claim 12, wherein in a case that the identified transmission protocol corresponds to the TCP, the instructions, when executed by the at least one processor individually or collectively, cause the system to adjust the advertise window size by:
determine an achieved background bandwidth associated with the at least one background application;
determine a window scaling factor advertise window based on at least the achieved background bandwidth and the background bandwidth limit;
determine a new background bandwidth limit associated with the at least one background application based on at least one of the background bandwidth limit, the achieved background bandwidth, or the window scaling factor,
determine a new advertise window size associated with the at least one background application based on at least the new background bandwidth limit, and
adjusting the advertise window size based on the determined new advertise window size to minimize the packet retransmission to the user device.

15. At least one non-transitory computer readable storage media storing computer-executable instructions that, when executed by at least one processor of a user device, cause the user device to:
determine a foreground application event associated with a foreground application at the user device;
determine a background bandwidth limit associated with at least one background application at the user device;
determining whether the background bandwidth limit exceeds a threshold value;
based on the background bandwidth limit exceeding the threshold value, identify a transmission protocol associated with the at least one background application; and
based on the identified transmission protocol, control packet transmission by at least one of:
delaying egress traffic; or
adjusting an advertise window size.
